(19) United States
(12) Patent Application Publication
(10) Pub. No.: US 2020/0085164 A1
(43) Pub. Date: Mar. 19, 2020

(54) APPARATUS WITH IMAGING FUNCTIONALITY

(71) Applicant: I-TWEEZERS CORPORATION, SAN JOSE, CA (US)

(72) Inventors: YORAM TAMIR, HAYWARD, CA (US); YECHIEL MANSOUR, JERUSALEM (IL)

(21) Appl. No.: 16/470,222

(22) PCT Filed: Dec. 18, 2017
(86) PCT No.: PCT/IB2017/058040

§ 371 Date: Jun. 16, 2019

Related U.S. Application Data
(63) Continuation-in-part of application No. 62/435,802, filed on Dec. 18, 2016.

(51) Int. Cl. A45D 26/00; G03B 29/00; G03B 15/03; H04M 1/725

(52) U.S. Cl. CPC A45D 26/0066; G03B 29/00; A45B 2009/002; H04M 1/7253; G03B 15/03

(57) ABSTRACT

A pincer apparatus, including two arms forming a pair of jaws at the arm tips, at least one camera positioned on the pincer apparatus, a communication port for transmitting an image captured by the camera to an external device including an image display, and a power source configured to power the camera and the communication port.

### CROSS-REFERENCE TO RELATED APPLICATIONS

This Application claims priority benefit from U.S. Provisional Application No. 62/435,802, filed Dec. 18, 2016, the disclosure of which is incorporated herein by reference in its entirety.

### BACKGROUND

Pincers typically have two pivoted arms forming a pair of jaws at its tips, and are generally used for gripping small objects.

Pincers are often used as tweezers for hair removal. Hair removal is often difficult due to difficulty in visualizing the hair to be removed, particularly when such hair is out of the user's direct visual field.

Pincers are also used during medical procedures for targeting small regions of body tissue. Where such medical procedures require high precision, this may likewise be difficult to achieve due to the difficulty in visualizing targeted regions.

### SUMMARY

There is provided according to some aspects of the invention, a pincer apparatus system comprising a pincer apparatus. The pincer apparatus may be configured with two arms forming a pair of jaws at the arm tips for gripping small-scale objects at an imaging region. The imaging region may be on a body of a user, in a non-limiting example. The pincer apparatus may comprise image capturing technology (ICT), such as a camera, for imaging the imaging region during the pincer apparatus operation. The captured image may be displayed on an image display module, such as a display enabling the user to visualize the gripping operation of the pincer apparatus.

According to some aspects of the invention, the pincer apparatus includes a hair removal apparatus. The hair removal apparatus may include any device for hair removal, such as tweezers. The tweezers are formed with a tweezer tip region configured to contact a single hair or plurality of hairs to be plucked or otherwise removed in any suitable manner at a hair removal region. The camera may be embedded, coupled or associated with the tweezers. The camera is configured to image the hair removal region for enabling a user to visualize the hair removal on the image display module.

According to some aspects of the invention, the pincer apparatus comprises two cameras or more for constructing a three-dimensional (3D) image of the imaging region.

In some aspects of the invention, the pincer apparatus tips may be electrically conductive. As electrical contact is made by physical mutual contact of the tips, a signal is generated and transmitted to a controller. The controller is programmed to activate a function in response to the signal. Such a function may include functions related to capturing the image and/or functions relating to activities of the image display module, for example.

In some aspects of the invention, a captured image may be transmitted to a third party for visualization of the image. For example, the pincer apparatus may capture an image and activate image processing for 3D visualizations. The 3D image data may be transmitted to a third party, such as transmitting an image for remote real time inspection of skin abnormalities e.g., Melanoma, to a medical practitioner.

There is provided according to some aspects of the invention, a pincer apparatus, including two arms forming a pair of jaws at the arm tips, at least one camera positioned on the pincer apparatus, a communication port for transmitting an image captured by the camera to an external device including an image display, and a power source configured to power the camera and the communication port.

In some aspects of the invention, the external device includes a mobile device.

In some aspects of the invention, a first and second camera may be included and are configured for constructing a three-dimensional image from a plurality of images captured by the first and second cameras.

In some aspects of the invention, a first and second camera may be included and are configured with a relatively narrow optical lens to provide a relatively narrow field of view. The second camera is configured with a relatively wide optical lens to provide a relatively larger field of view.

In some aspects of the invention, the pincer apparatus further includes a base element. The two arms are connected thereto via the base element. The two arms are formed of an electrically conducting material and the base element is formed of an electrically isolating material. In some aspects of the invention, upon mutual contact of the tips formed of the electrically conducting material, a signal is generated.

In some aspects of the invention, the pincer apparatus further includes a controller. The controller is configured for receiving the signal and being programmed to activate a function in response to the signal.

In some aspects of the invention, the pincer apparatus further includes a sensor for detecting the signal.

In some aspects of the invention, the pincer apparatus further includes adapters structured with a selected tool for performing a procedure. The adapters may be shaped to be inserted on the tips.

In some aspects of the invention, the pincer apparatus includes tweezers configured for hair removal.

There is provided according to some aspects of the invention, a pincer apparatus system including a pincer apparatus, configured with two arms forming a pair of jaws at the arm tips, at least one camera positioned on the pincer apparatus, a communication port, and a power source configured to power the camera and the communication port, and an external device including a receiver port for receiving images captured by the camera and transmitted from the communication port, and an image display for displaying the captured images thereon.

In some aspects of the invention, the pincer apparatus system further includes a base element, where the two arms are connected thereto via the base element, and where the two arms are formed of an electrically conducting material and the base element is formed of an electrically isolating material. In some aspects of the invention, upon mutual contact of the tips formed of the electrically conducting material, a signal is generated.

In some aspects of the invention, the pincer apparatus system further includes a controller. The controller is configured for receiving the signal and being programmed to activate a function in response to the signal In some aspects of the invention, the pincer apparatus system further includes a sensor for detecting the signal.

In some aspects of the invention, the pincer apparatus system further includes adapters structured with a selected tool for performing a procedure. The adapters are shaped to be inserted on the tips.

There is provided according to some aspects of the invention, a hair plucking apparatus including tweezers structured for plucking hairs formed with a tweezers tip region configured to contact a single hair or plurality of hairs to be plucked, at least one camera positioned on the tweezers, and a communication port for transferring images captured by the camera to an external device including an image display for displaying the images thereon.

There is provided according to some aspects of the invention, a method for imaging a gripping procedure via a gripping procedure imaging application operating on a mobile device. The method may include activating the imaging application on the mobile device, receiving image data from a pincer apparatus equipped with a camera for capturing an image of the gripping procedure, processing the received image data, and displaying the resultant captured image on a display of the mobile device.

In some aspects of the invention, the method further includes manipulating the image. In some aspects of the invention, the method further includes transmitting the image data to other devices including a display.

There is provided according to some aspects of the invention, a method for imaging hair removal via a hair removal imaging application operating on a mobile device. The method may include activating the imaging application on the mobile device, receiving image data from a hair removal apparatus equipped with a camera for capturing an image of the hair removal, processing the received image data, and displaying the resultant image on a display of the mobile device.

There is provided according to some aspects of the invention, an imaging apparatus, including a pole, at least one camera positioned along the pole, a communication port for transmitting an image captured by the camera to an external device including an image display, and a power source configured to power the camera and the communication port.

In some aspects of the invention, the external device includes a mobile device.

In some aspects of the invention, the imaging apparatus further includes a first and second camera configured for constructing a three-dimensional image from the images captured by the first and second cameras.

In some aspects of the invention, the imaging apparatus further includes a signal generator, which upon prompting generates a signal, which activates a function in response to the signal.

In some aspects of the invention, the imaging apparatus further includes a controller. The controller is configured for receiving the signal and is programmed to activate a function in response to the signal.

In some aspects of the invention, the imaging apparatus further includes a sensor for detecting the signal.

In some aspects of the invention, the pole includes a hiking stick. In some aspects of the invention, the pole includes a cane. In some aspects of the invention, the pole includes a camera rod.

There is provided according to some aspects of the invention, an imaging apparatus, including an instrument, at least one imaging device positioned along the instrument, a communication port for transmitting an image captured by the imaging device to an external device including an image display, and a power source configured to power the imaging device and the communication port.

There is provided according to some aspects of the invention, a method for imaging an imaging region via an imaging application operating on a mobile device. The method includes activating the imaging application on the mobile device, receiving image data from an imaging apparatus equipped with a camera for capturing an image of the imaging region, processing the received image data, and displaying the resultant image on a display of the mobile device.

### BRIEF DESCRIPTION OF THE DRAWINGS

Aspects of the invention will be understood and appreciated more fully from the following detailed description taken in conjunction with the appended drawings in which:

FIG. 1 is a simplified, exemplary illustration of a pincer apparatus, constructed and operative according to some embodiments of the invention;

FIG. 2 is a simplified, exemplary illustration of a pincer apparatus system, constructed and operative according to some embodiments of the invention;

FIGS. 3A and 3B are each a simplified, exemplary illustration of a pincer apparatus system, constructed and operative according to some embodiments of the invention;

FIG. 4 is a simplified, exemplary illustration of a pincer apparatus system, constructed and operative according to some embodiments of the invention;

FIG. 5 is a simplified, exemplary illustration of a pincer apparatus system, constructed and operative according to some embodiments of the invention;

FIG. 6 is a simplified, exemplary illustration of a pincer apparatus system, constructed and operative according to some embodiments of the invention;

FIGS. 7A-7C are each a simplified, exemplary illustration of a pincer apparatus, constructed and operative according to some embodiments of the invention;

FIG. 8 is a simplified, exemplary illustration of a pincer apparatus, constructed and operative according to some embodiments of the invention;

FIG. 9 is a simplified, exemplary illustration of a pincer apparatus, constructed and operative according to some embodiments of the invention;

FIG. 10 is a simplified, exemplary illustration of a pincer apparatus system, constructed and operative according to some embodiments of the invention;

FIG. 11 is a simplified, exemplary flowchart of a pincer imaging application operating on a mobile device, constructed and operative according to some embodiments of the invention;

FIGS. 12A and 12B are a simplified, exemplary illustration of an imaging apparatus system (12A) and an imaging apparatus (12B), constructed and operative according to some embodiments of the invention;

FIG. 13 is a simplified, exemplary illustration of an imaging apparatus system, constructed and operative according to some embodiments of the invention;

FIG. 14 is a simplified, exemplary illustration of an imaging apparatus system, constructed and operative according to some embodiments of the invention;

FIG. 15 is a simplified, exemplary illustration of an imaging apparatus system, constructed and operative according to some embodiments of the invention; and

FIG. 16 is a simplified, exemplary illustration of an imaging apparatus system, constructed and operative according to some embodiments of the invention.

### DETAILED DESCRIPTION

In the following description, various aspects of the invention will be described with reference to different embodiments. For purposes of explanation, specific configurations and details are set forth in order to provide a thorough understanding of the invention. However, it will also be apparent to one skilled in the art that the invention may be practiced without the specific details presented herein. Furthermore, well-known features may be omitted or simplified in order not to obscure the invention.

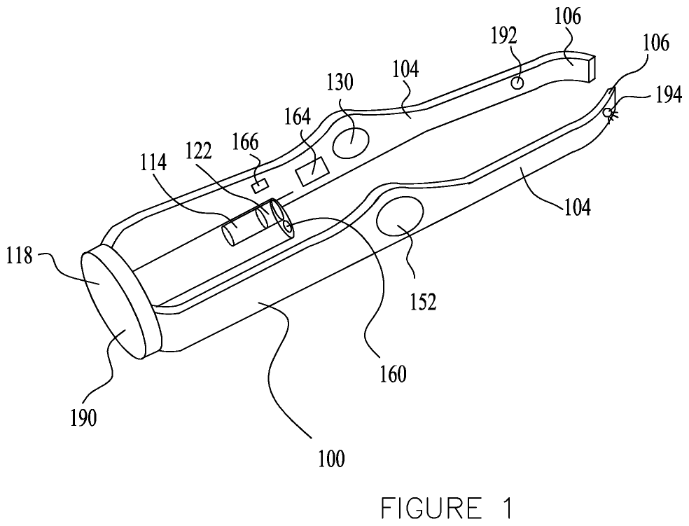

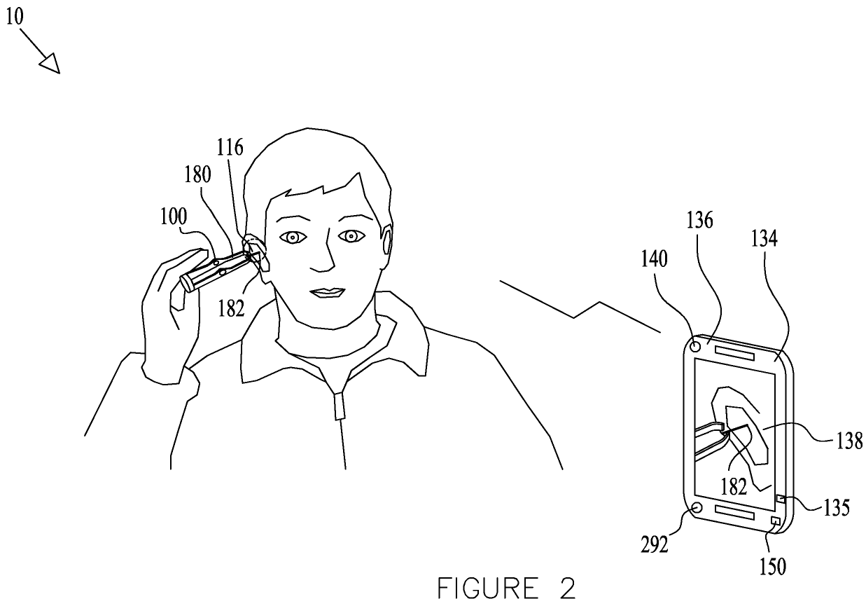

Referring to FIGS. 1-6, a pincer apparatus system 10 is shown in FIG. 2, in which a pincer apparatus 100 (FIG. 1) is configured with two arms 104 forming a pair of jaws at the pincer tips 106 at a region surrounding the tips. The pincer tips 106 are configured to grip an object, such as a small-scale object. In some embodiments, the small-scale object may be a body part or other object, such as a hair.

The pincer apparatus 100 may include apparatuses employing image capturing technology (ICT). The ICT may include any suitable imaging means or imaging device, and in some embodiments may include at least one camera 114 positioned at any suitable location on the pincer apparatus 100.

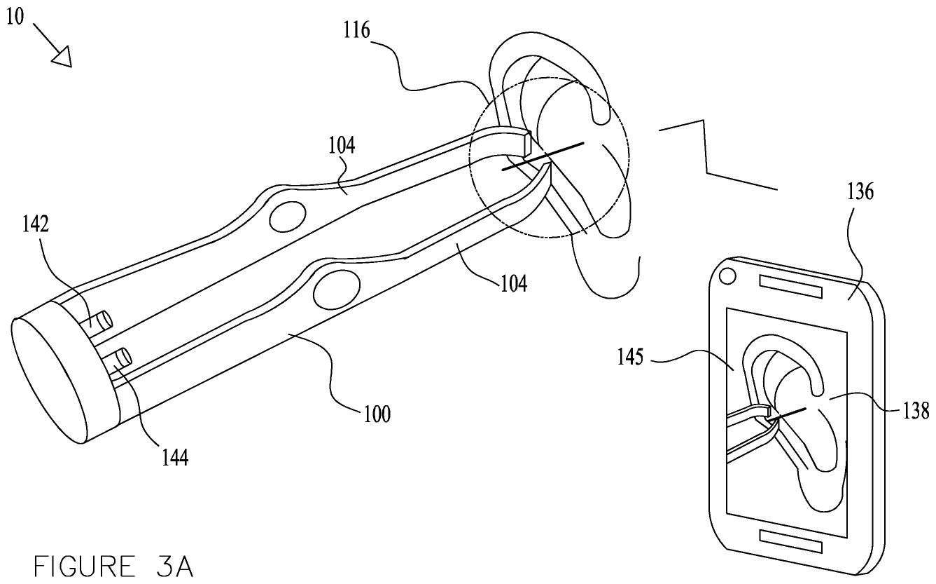

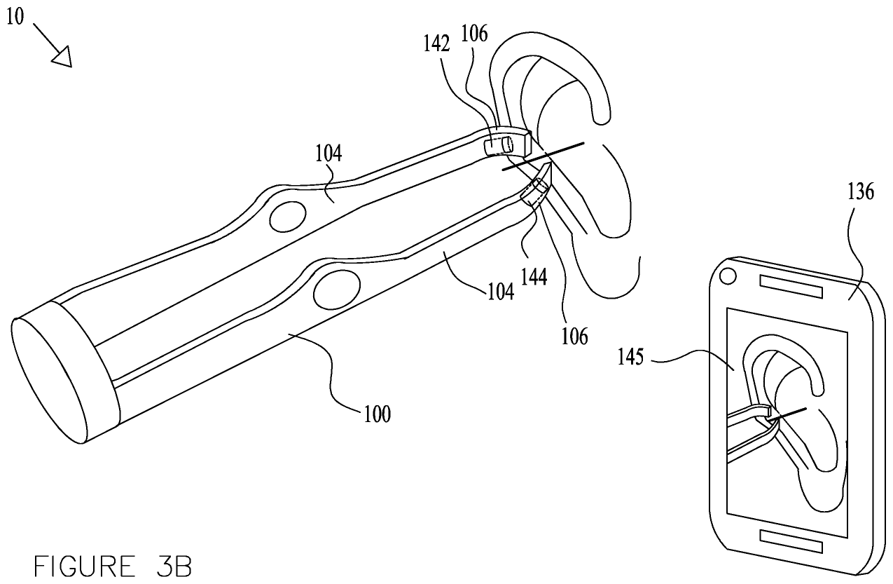

The camera 114 is configured to capture an image of an imaging region 116 (shown in FIGS. 2 and 3A) located about pincer tips 106, generally comprising a region of a body area where the pincer tips 106 contact the targeted object. The captured image is transmitted, using any suitable technique, to an external device 134, comprising an image display 138 (shown in FIG. 2). The displayed image of the imaging region 116 about pincer tips 106 provides for enhanced visualization of the gripping procedure, which would have otherwise been impossible or difficult to see.

As seen in FIG. 1, the camera 114 may be positioned at or in proximity to a base region 118 of the pincer apparatus 100 to gain a wide focal field of view for capturing the image at the imaging region 116. Base region 118 is at the opposite end of arms 104 from where pincer tips 106 are located.

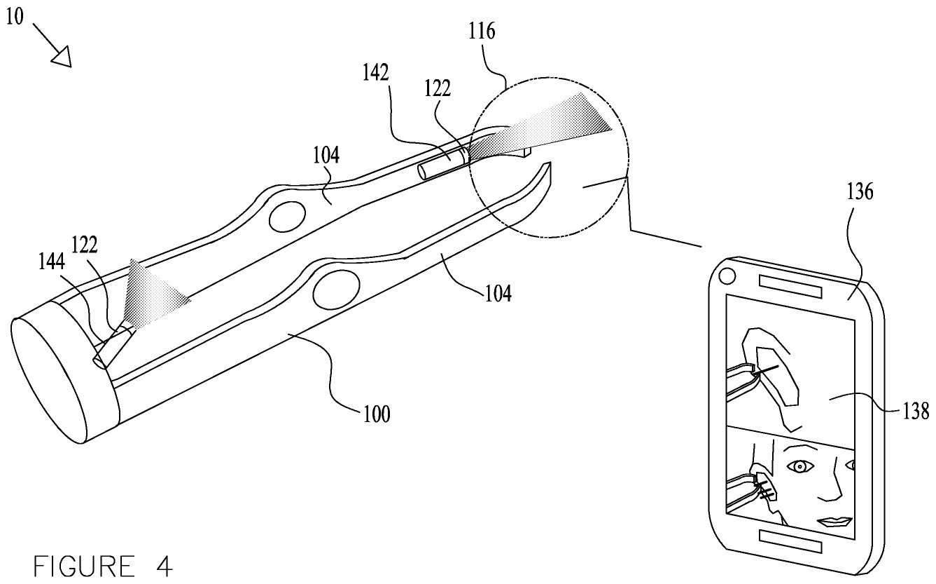

In some embodiments, as shown in FIG. 4, the camera 114 (shown as camera 142) may be positioned relatively proximate to the imaging region 116. In a non-limiting example, the camera 114 may be positioned at a distance in the range of about 1-10 centimeters, or in the range of about 1-5 centimeters, or in the range of about 2 centimeters or less, from the pincer tips 106.

The camera 114 may comprise an analog or digital camera designed to capture still or streamed images and/or videos and store and/or transmit them for display and/or analysis. The camera 114 may comprise a miniature camera with relatively small dimensions allowing the camera 114 to be positioned on the pincer apparatus 100 or embedded therein. A non-limiting example of a miniature camera may comprise a length of about 5 mm and a diameter in the range of 2-4 mm or even less than 2 mm. Such a camera may, for example, be the micro ScoutCam™, commercially available from Medigus, Ltd. of Omer, Israel. In some embodiments, the miniature camera may have a length and a diameter in the range of a few millimeters to a few decimeters, and subranges thereof.

The camera may comprise a camera with relatively small dimensions, yet configured to provide a large enough field of view for imaging the imaging region 116.

In some embodiments, the camera 114 may comprise a photosensitive image sensor which may include a Charge-Coupled Device (CCD) or a Complementary Metal-Oxide-Semiconductor (CMOS) and is designed for capturing the image and producing image data comprising electronic image information representing the image. The photosensitive image sensor may be disposed approximately at an image focal point plane of an optical lens 122 of the camera 114. The optical lens 122 is positioned on the pincer apparatus 100 so as to focus light received from the targeted imaging region 116 of a body part or any other desired image region to the photosensitive image sensor. The optical lens 122 may comprise a fixed or varifocal aperture to control the focal field of view of the targeted image frame captured by the camera 114.

The camera 114 may be configured with a visual field of view, which may be fixed or variable. The camera 114 may be configured with an angle of view, which may be fixed or variable.

The pincer apparatus 100 may comprise a communication port 130 for transmitting image data or signals to the external device 134 and/or for receiving signals from a controller 164 and/or the external device 134. The image data may be received from the camera 114. The transmission of the image data from the camera 114, via the communication port 130, may be controlled by the controller 164 or by any other controller, such as a controller 135, shown in FIG. 2, of the external device 134.

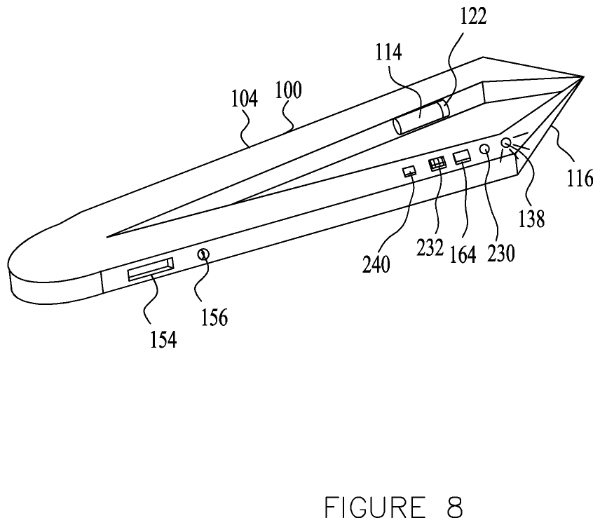

The communication port 130 may for example, include a transmitter, a transponder, an antenna, a transducer, an RLC circuit, wireless and/or wired communication means. In some embodiments, the communication port 130 may comprise connection ports and interfaces such as a HDMI port, an A/V port, an optical cable port, a USB port 154 and/or an A/V connection port 156 (FIG. 8).

The external device 134 may be any apparatus configured to receive the data related to the image. In some embodiments, such as in FIG. 2, the external device 134 may comprise a mobile device 136, such as a mobile phone. In some embodiments, the external device 134 may be any type of device having computing capabilities, such as, but not limited to, a personal computer, a cellular phone, a smartphone, a tablet, a blackberry, a personal digital assistant (PDA), an ultra-mobile PC, a television, a video monitor, an audio system, GOOGLE GLASS®or a similar device, for example.

The external device 134 may comprise an image display module, such as the display 138 for displaying the image captured by the camera 114 showing the imaging region 116.

The display 138 may comprise an electronic display, such as a digital display, an analog display, or a projection screen illuminated by any suitable image source.

The external device 134 may comprise a receiver port 140 for receiving the image data from the pincer apparatus 100 wirelessly or via a wired connection. The captured image frames may be presented as still images, streaming images, a series of images, a video, sub-layers of the captured image or any other suitable presentation.

In some embodiments, more than a single image may be simultaneously displayed on the display 138 (FIG. 4).

Turning to FIGS. 3A, 3B and 4, it is seen that in some embodiments the pincer apparatus 100 may comprise a plurality of cameras 114, such as first and second cameras 142 and 144.

In the embodiment of FIGS. 3A and 3B, the first and second cameras 142 and 144 are provided for constructing a three-dimensional (3D) image from the captured image frame.

The cameras 142 and 144 may be positioned at any suitable location, such as at the base region 118 as shown in FIG. 3A, or along the arms 104 or in proximity to the pincer tips 106, as shown in FIG. 3B.

The 3D image reconstruction may be performed by any suitable technique, where some exemplary techniques may include photometric stereo processing, which uses multiple 2D images obtained from a fixed camera perspective with different illumination directions. Another exemplary technique may comprise structured illumination, which uses a calibrated projector-camera pair. A light pattern is projected onto the scene and imaged by the cameras 142 and 144. A further exemplary technique comprises stereoscopic vision processing, which reconstructs a 3D object by deducing the spatial shape and position of the object through parallax between the corresponding pixels from different images of the object as observed from multiple viewpoints. The 3D image reconstruction may be performed by using any suitable component, such as cameras 142 and 144 the lenses 122 and the controller 164 and/or electric components 166, which may be configured to performed the 3D image reconstruction.

The resultant 3D image 145 is displayed on the display 138. The 3D image 145 may be greatly advantageous for aiding in the performance of medical procedures, such as image-guided medical procedures.

In the embodiments shown in FIG. 4, the first camera 142 is positioned in proximity to the imaging region 11.6. In some embodiments, the first camera 142 may be configured with a relatively narrow, namely telephoto, optical lens 122. to provide a high-resolution, relatively narrow field of view. The second camera 144 may be positioned away from the imaging region 116 and may be configured with a relatively wide optical lens 122 to provide a relatively wider field of view.

In some embodiments, the second camera 144 may be positioned at an angle relative to the first camera 142.

in some embodiments, both the resultant smaller and larger field of view images may be simultaneously displayed on the display 138, as shown in FIG. 4, where the upper image is captured by the first, smaller field of view camera 142 and the lower image is captured by the second, wider field of view camera 144.

In some embodiments, the user may select the desired field of view by selecting the activation of a desired camera, e.g. the first camera 142 or the second camera 144. in some embodiments, the selection may be performed by a control button or by triggering generation of a signal to a controller 164, as will be further described and/or may be performed via an application operating on the mobile device 136.

In some embodiments, as shown in FIG. 4, in a non-limiting example, the cameras 142 and 144 and their associated optical lenses 122, may be positioned at different relative proximity to the imaging region 116 to achieve different images with different fields and depths of views.

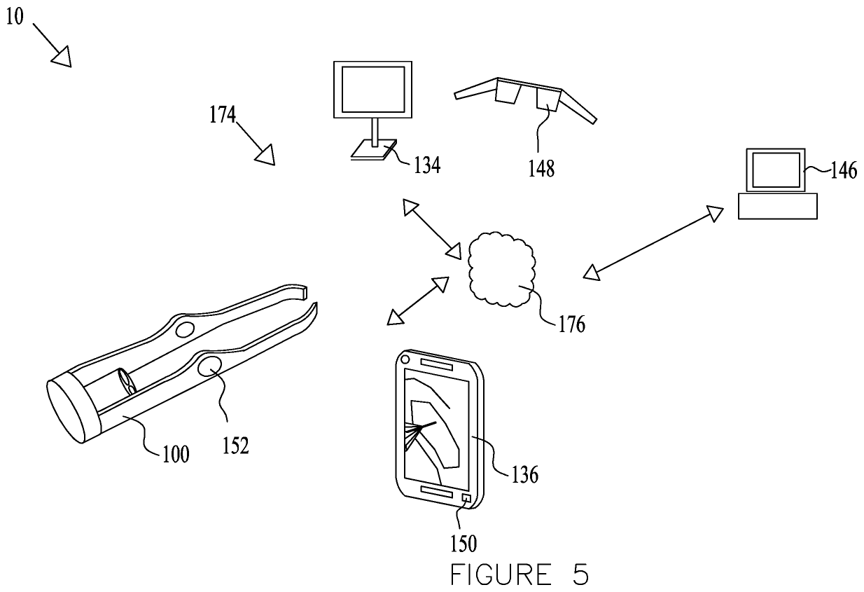

As seen in FIG. 5, in some embodiments, the external device 134 may comprise functionality for processing the image data and/or for further transmitting the image data to another external device, such as a central database 146, or another external device 134 comprising an imaging device 148, e.g. a three-dimensional (3D) visor/glasses, such as GOOGLE GLASS® or any other suitable imaging mechanism and/or image data processing device.

In some embodiments, the external device 134 may receive unprocessed, raw imaging data from the pincer apparatus 100 and may perform the image processing by using the existing processing functions embedded therein, such an image processor 150 embedded within the mobile device 136.

The pincer apparatus 100 may be provided with a power supply source. In some embodiments the power source 152 may include a rechargeable or disposable battery, a backup battery, a microgenerator, and/or a wired or wireless connection to electricity or another power source. In some embodiments, the power source may be provided by the external device 134.

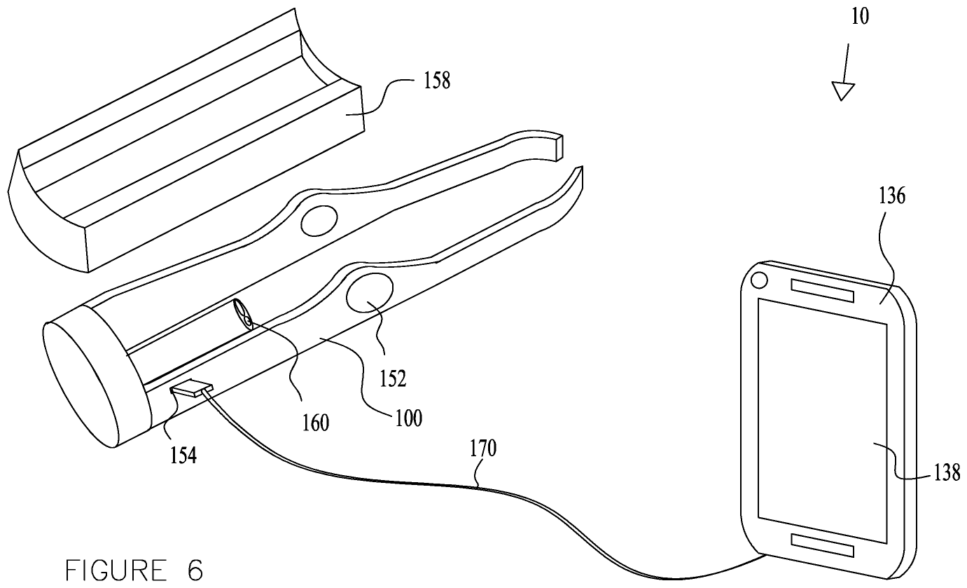

The pincer apparatus 100 may be configured to fit into a recharging cradle 158 (FIG. 6) for recharging the battery 152, typically when inactive.

In some embodiments, the battery 152 may comprise a small sized battery, such as including a length in the range of about 1-4 centimeters and a width of 1-2 centimeters and subranges thereof. In some embodiments, the battery may comprise a length in the range of about 2.4-4 centimeters and a width of 1.6-2 centimeters and subranges thereof. In some embodiments, the battery 152 may be configured to provide power for about an hour, or a half an hour, or 2 hours or more, of operation.

In some embodiments, the pincer apparatus 100 may comprise an illuminator 160, such as a LED, an incandescent light or any other light for illuminating the imaging region 116.

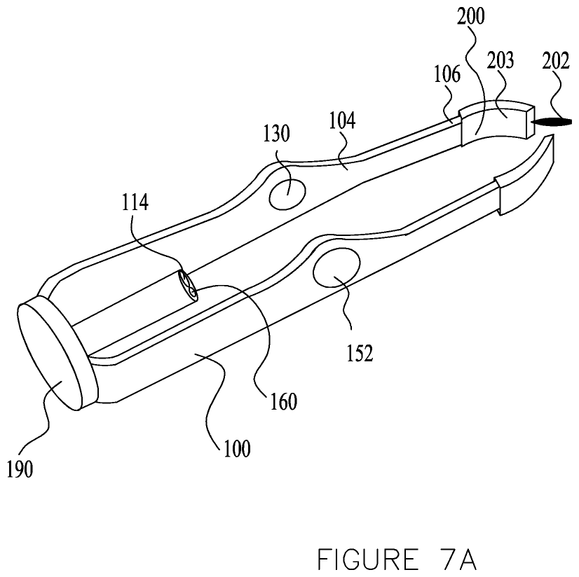

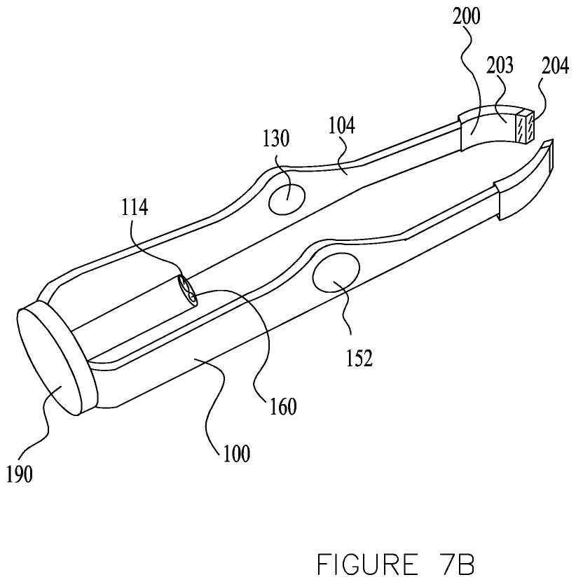

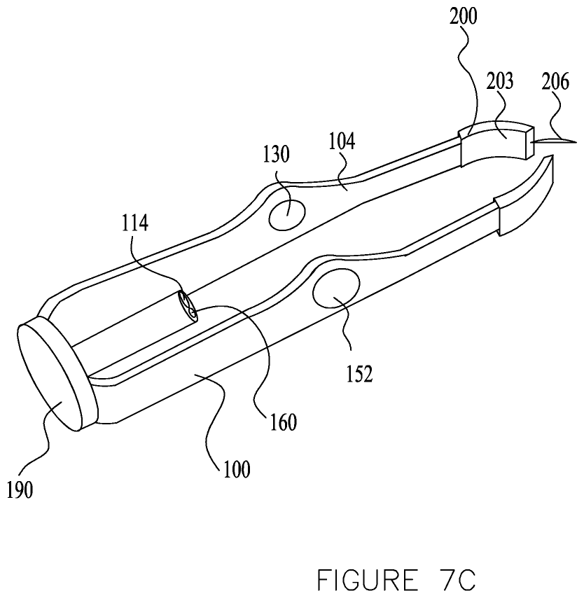

In sonic embodiments the pincer apparatus 100 may comprise a magnifier, such a will be described in reference to FIG. 7E.

In some embodiments, the pincer apparatus 100 may further comprise at least one controller 164, shown in FIG. 1, including a central processing unit (CPU) for controlling the operation of the components of the pincer apparatus 100, such as the camera 114, communication port 130, the power source (e.g. battery 152), illuminator 160 and/or electronic components and/or connectors 166. The electronic components 166 may comprise any suitable components for detecting, processing, storing and/or transmitting image data or signals, such as electrical circuitry, an analog-to-digital (A/D) converter, and an electrical circuit for analog or digital short-range communication, for example, as well as electronics for providing the components of the pincer apparatus 100 with power supply or electronic contacts between the components of the pincer apparatus 100.

Communication between the pincer apparatus 100 and the external device 134, shown at least in FIGS. 2-6, may be provided by any suitable communication module, which may include in a non-limiting example, wireless communication means, as shown in FIG. 2, such as by cellular or WiFi communication, acoustic communication, Radio Frequency (RF), Bluetooth, Ultra Sound communication, Light Transmission means, infrared or other wireless communication means. The communication module may comprise wired communication facilitated by any suitable means such as twisted pair, coaxial cable, cables, fiber optics, wave guides, Ethernet or USB or any other wired media, as seen for example in FIG. 6, where the communication module between the pincer apparatus 100 and the external device 134 is wired, via a cable 170.

The transfer of the image data or any other related information via the communication module to the mobile device 136 and/or to the central database 146, or another external device 134 may be performed in any suitable manner, such as by a communication network 174 and/or a remote computing device, shown in FIG. 5. The communication network 174 may include a cloud computing service 176 (also referred to as a cloud) having a cloud server and cloud storage in communication with a portal e.g., web portal, for receiving/transmitting content. The communication network 174 may comprise a local area network (“LAN”), a wide area network (“WAN”), and the Internet, for example, to allow information transfer thereby or any other suitable communication network 174.

In some embodiments, a captured image may be transmitted via the communication network 174 or any other means, to a third party for visualization of the image. For example, the pincer apparatus 100 may capture an image and activate image processing or reconstruction for 3D visualizations and image data transfer via the communication network 174 to a third party. For example, an image is transmitted for remote real-time inspection of skin abnormalities, e.g., Melanoma, to a medical practitioner.

In some embodiments, the camera 114 may be used to detect the spatial position of the small-scale object or body region, such as via a Global Positioning System (GPS).

The pincer apparatus 100 may be used for various procedures wherein gripping small-scale objects is required. In the non-limiting example of FIG. 2, the pincer apparatus 100 may be used as tweezers 180 designed to pluck a single or a plurality of hairs 182 from a user's body. The image of the imaging region 116, shown as a hair removal region, is captured by camera 114 and is displayed on the display 138, thereby allowing the user to visualize the otherwise inconspicuous hair removal region.

In some embodiments, the pincer apparatus system 10 may be configured to perform a plurality of functions, such as functions related to image capturing of the imaging region 116. In a non-limiting example, such functions may include: turning the pincer apparatus 100 on or off, magnifying the field of the image size by zooming in or out, adjusting the angle of the image to be captured, changing the field of view, selecting any one of a plurality of cameras, capturing the image, saving the captured image, sharing the image with other users, turning the illuminator 160 on or off, 3D rotation of the image, etc.

Furthermore, the functions may include a plurality of activities such as mechanical activities, visual activities, acoustical activities, wired or wireless activities and a combination thereof, which may be performed by any component of the pincer apparatus system 10.

In some embodiments, these functions may be controlled by an application operating on the mobile device 136.

Additionally, or alternatively, the functions may be controlled, at least partially, by a signaling mechanism configured to generate signals by the pincer apparatus 100. In some embodiments, each of arms 104 may be formed of electrically conducting materials, such as a metal. The arms 104 may be electrically isolated from each other by a base element 190, shown in FIG. 1 at the base region 118. The base element 190 may be formed of any suitable electrical isolator, such as a plastic, for example. Upon mutual physical contact (or any other activity) of the electrically conductive pincer tips 106, electrical contact is formed, thereby generating a signal. The controller 164 may be programmed to activate a function in response to the signal.

Some exemplary signal patterns generating preprogrammed functions may include: an initial clicking together of the pincer tips 106 may generate a signal to activate the mobile device 136 and/or the pincer apparatus 100; a double clicking together of the pincer tips 106 in rapid succession may generate another signal, which may trigger turning on the illuminator 160; a clicking together of the pincer tips 106 without any further detected activity following a predetermined time thereafter may generate another signal to deactivate the mobile device 136 and/or the pincer apparatus 100, thereby conserving the energy of battery 152. Other exemplary patterns of clicking together of the pincer tips 106 may include generating a signal to capture the image and/or transmitting the captured image to the mobile device 136.

The signal may be generated in any suitable manner, such as by opening or closing an electrical circuit; by generating an analog or digital wired or wireless signal; generating an acoustical, vibration, motion, optical, magnetic, optical and/or neurological signal which may be detected in any suitable manner, such as by a sensor 192, for example, or a combination thereof. In a non-limiting example, the clicking sound of the pincer tips 106 may be detected by an acoustic detector which may generate the signal which prompts the activation of a predetermined function.

The sensor 192 may include any one of: the acoustic sensor, accelerometer, magnet, microphone, optical sensor, motion sensor, thermal sensor, vibration sensor or a combination thereof, for example.

The signal may be transmitted to the controller 164 and/or to the external device 134 or in any suitable manner, such as by analog or digital wired or wireless transmission by acoustical, vibration, optical, magnetic and/or optical transmission or a combination thereof.

The signals may be transmitted to the controller 164 and may be further processed by the controller 164. Additionally, or alternatively the signals may be transmitted and/or processed by a controller at any type of external device 134, such as by the controller 135 of the mobile device 136, shown in FIG. 2.

It is appreciated that the controller 164 may be programmed to activate many different types of functions related to the operation of the pincer apparatus 100 and/or the external device 134 and/or the communication therebetween.

In some embodiments, the pincer apparatus 100 may further comprise audio components 194, such as a microphone, buzzer, audio ports for headphone or any other external player device. Upon generation of the signal by the clicking together of the pincer tips 106, an audio signal (e.g. beep) may be generated and detected by sensor 192. The audio signals may serve to aid in monitoring the signals generated by the clicking together of the pincer tips 106. For example, the audio signals may be used to indicate the number and/or duration of the clicks and the intervals intermediate consecutive clicks.

In some embodiments, the audio components may comprise a microphone for controlling the pincer apparatus system 10 verbally by employing speech recognition functionality. This may be used by visually impaired users, for example.

In some embodiments, any one of the sensors 192 and/or audio components 194 may be embedded in the external device 134. The controller 164 may be operative to activate and control the sensors 192 and/or audio components 194 embedded within the external device 134.

In FIGS. 7A-7C, the pincer apparatus 100 is shown configured for a variety of procedures. The pincer apparatus 100 may be used for any gripping procedure, such as for tweezing hairs, plucking hairs or removal of any objects, such as generally small-scale objects. Furthermore, the pincer apparatus 100 may be used for piercing, pinching, incising, cutting, slicing, stripping, welding, sewing, marking, painting, coloring and magnifying, for example. The procedures may be employed in various practices, such as in medical or dental practices (e.g., during image-guided surgery, and where welding may be used for closing blood vessels) or aesthetic/cosmetic practices, for example.

A small-scale object may comprise objects of a given size (length, width and/or diameter), such as of about a few centimeters or less, or about 10 centimeters or less, or about 5 centimeters or less, or about 1 centimeter or less, or about 900 millimeters or less, or about 500 millimeters or less, or about 100 millimeters or less, or about 10 millimeters or less and subranges thereof.

In some embodiments, the pincer apparatus 100 may be structured with elements for performing any one of the variety of procedures. In some embodiments, the pincer apparatus 100 may be provided with adapters 200 structured with a selected tool for performing any one of the variety of procedures.

FIG. 7A shows an exemplary adapter 200 formed with a tool comprising a brush 202 at an adapter tip 203. The brush 202 may be used in the medical practice to mark a body area prior to a medical procedure, for example. The brush 202 may be used in the cosmetic field for facial coloring, for example. The adaptor 200 may be sized and shaped to be inserted at least partially on the pincer tips 106 or attached to the pincer tips 106.

FIG. 7B shows an exemplary adapter 200 formed with a tool comprising a magnifying glass or other material 204 positioned at the adapter tip 203 used in addition to another procedure or to magnify a desired area.

FIG. 7C shows an exemplary adapter 200 formed with a tool comprising a scalpel 206 at the adapter tip 203, which may be inserted on the pincer tip 106. The scalpel 206 may be used in medical practice to incise a body area during a medical procedure, for example.

As seen in FIG. 8, the pincer apparatus 100 may be configured with a plurality of buttons and controllers which may replace, or be added to, the signaling mechanism described hereinabove. In some embodiments, in addition to at least one of the camera 114, controller 164, electrical components 166, battery 152, power supply connectors 154 and 156, communication port 130 and illuminator 160, the pincer apparatus 100 may comprise an activation button 230 for turning the pincer apparatus 100 on and/or off Further buttons 232 may be provided for controlling a plurality of functions, such as functions related to image capturing of the imaging region 116, as described herein. The pincer apparatus 100 may comprise the USB port 154 and/or the AC connection port 156.

In some embodiments, the pincer apparatus 100 may be configured as a monolithic unit, as shown in FIG. 8.

In some embodiments, the pincer apparatus 100 may comprise an image processor 240 for processing the image data provided by the camera 114. in some embodiments, the image processor 240 may be integrated into the camera 114 or in some embodiments may be a separate component embedded in the pincer apparatus 100 or the external device 134.

In the embodiments described with reference to FIGS. 1-8, the pincer apparatus components, such as the camera 114, controller 164, electrical components 166, battery 152, power supply connectors 154 and 156 and communication port 130, are embedded in the pincer apparatus 100.

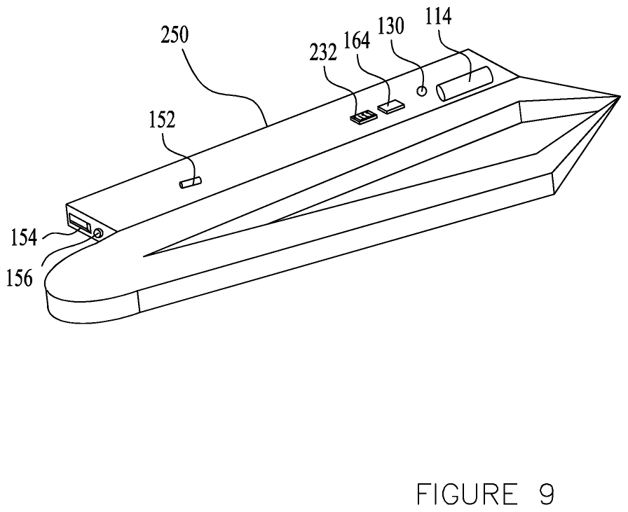

Turning to FIG. 9, an auxiliary attachment 250 is shown in which the pincer apparatus components are embedded therein. In some embodiments, the auxiliary attachment 250 may comprise the controller 164 preprogrammed to activate a function in response to a signal generated in any suitable manner, such as by clicking together of the pincer tips 106, as described herein.

The auxiliary attachment 250 may be configured to engage with any pincer, such as with any known type of tweezers, in any suitable manner, such as by a snap-fit engagement.

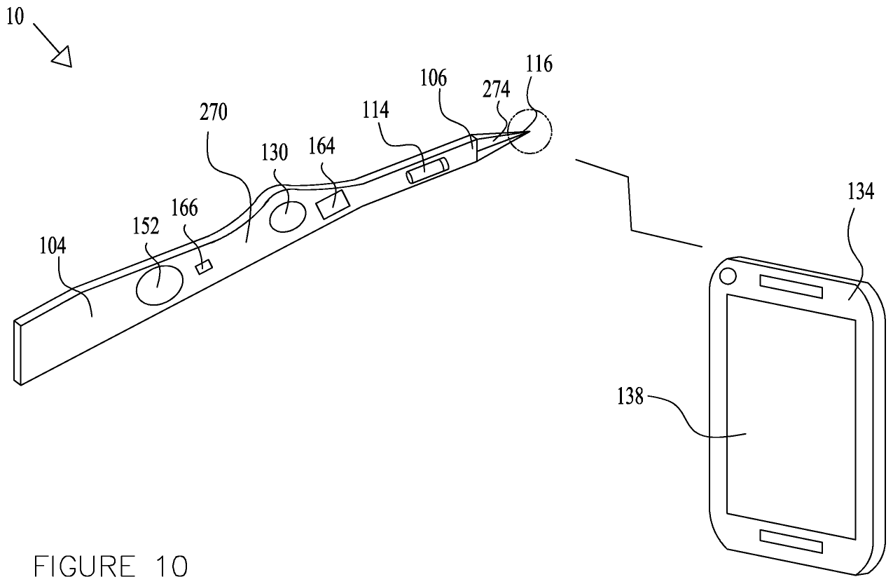

Referring to FIG. 10, it is seen that the pincer apparatus 100 may comprise a single arm 104 forming an imaging apparatus 270. At the pincer tip 106 there may be provided a tool for performing a procedure. In some embodiments, the imaging apparatus 270 may comprise a scalpel 274. The imaging apparatus 270 may comprise at least one of the power source 152, communication port 130, controller 164 and camera 114 for capturing an image of an imaging region 116, which may include the region where pincer tip 106 contacts the targeted body part and its vicinity. The captured image is transmitted to the external device 134 comprising the display 138.

In some embodiments, the imaging apparatus 270 may comprise the controller 164 preprogrammed to activate a function in response to a signal generated in any suitable manner, such as by agitating the imaging apparatus 270 in any suitable manner. In a non-limiting example, whereupon the user touches the pincer tip 106, a signal is generated. Such a signal may be a vibration signal detected by an accelerometer.

FIG. 11 is an exemplary flowchart of a method for imaging with pincer apparatus 100. In this exemplary flowchart pincer apparatus 100 employs tweezers, such as tweezers 180 of FIG. 2, for imaging hair during hair removal, though it is appreciated that the method is applicable to any procedure using the pincer apparatus 100.

In the exemplary embodiment of FIG. 11 the method is utilized at least partially by a hair removal imaging application. The hair removal imaging application may operate on the mobile device 136. At step 280 the imaging application is activated. At step 282 the image data is received from the tweezers, by wired or wireless communication, and is processed by the controller 164, as seen at step 284. The image data may comprise the captured image frame and any other required data, such as data pertaining to the user (age, location etc.). The image data may be transmitted via the communication port 130 or any other suitable manner.

At step 286 the resultant processed image is displayed on the display 138.

The imaging application may provide a plurality of optional functions. In some embodiments, as shown at step 288, the application may provide functionality for the user to carry out any of the function described herein. The functions may further comprise manipulating the image such as by zooming the image in or out, freezing a frame of a video image and/or cropping the image, for example. The application may provide functionality for the user to control the illumination, such as the off or on state of the illuminator 160.

As seen at optional step 290, in some embodiments the application may provide functionality for storing the image in any suitable format within a memory element 292 (FIG. 2) of the mobile device 136 or a memory of any other external device 134.

The application may further provide a sharing feature, as shown in optional step 296, allowing the user to share the image with other users via the network 174 (FIG. 5) in any suitable format such as by SMS, email, or an application for transferring data, for example.

It is noted that some steps described may be omitted. The order of the steps may change.

It is noted that the description herein of FIGS. 1-11 mainly refers to a pincer apparatus 100 such as tweezers and hair removal by plucking, yet it is appreciated that what is described herein is applicable to any apparatus and method for performing a procedure that generally involves a small-scale object or a region on the body.

In some embodiments, the pincer apparatus system 10 may be used for visualizing procedures performed on small-scale objects on any platform and not only on a body region, such as are encountered in industrial settings, and the small scale-objects may be inanimate objects, (e.g. electric components) for example.

In a non-limiting example, the pincer apparatus 100 may comprise other types of hair removal devices such as a shaver, such as an electric reusable shaver or a mechanical reusable or disposable shaver; a mechanical epilator, a diode epilator, an electrolysis device; or a hair removal laser device.

In some embodiments the method for imaging with pincer apparatus 100 may include a method for imaging a gripping procedure via a gripping procedure imaging application operating on the mobile device 136. The method may comprise activating the imaging application on the mobile device 136; receiving image data from the pincer apparatus 100 equipped with a camera capturing an image of the gripping procedure; processing the received image data; and displaying the resultant image on a display 138 of the mobile device 136. In some embodiments, the image may be manipulated, e.g. enlarged, spliced, shaded. In some embodiments, the image data may be transmitted to other external devices 134 comprising the display 138.

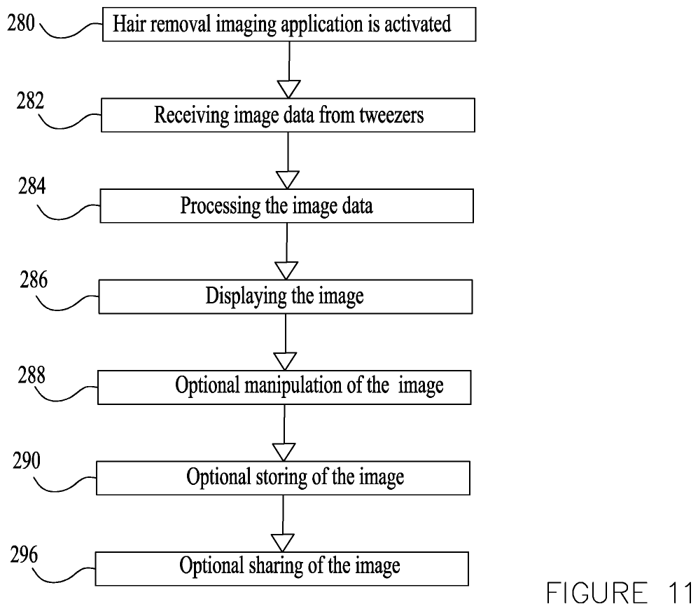

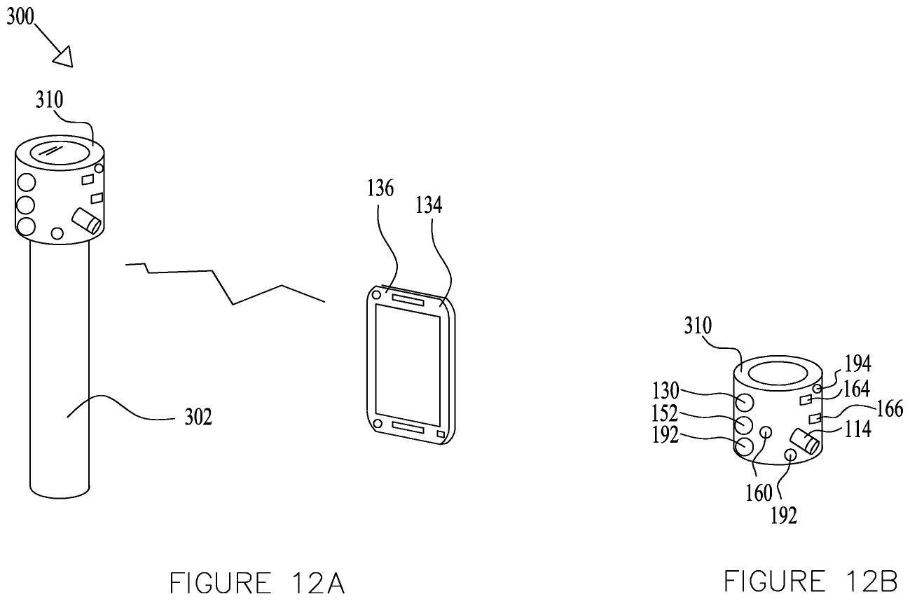

Referring to FIGS. 12A and 12B, an imaging apparatus system 300 is shown in FIG. 12A, comprising a pole 302 and an imaging apparatus 310. The imaging apparatus 310 employs image capturing technology (ICT), such as at least one camera 114. The camera 114 is configured to capture an image of the imaging region 116, which may include any selected region, typically an inconspicuous (namely, difficult to visualize) area. The imaging region 116 may include any sized region and the captured image may include any sized object or area, including small-scale objects as well as large-scale objects (e.g. larger than 10 centimeters)

Imaging apparatus 310 may further comprise the communication port 130 for transmitting image data or signals to the external device 134 (e.g. mobile device 136) and/or for receiving signals from the controller 164 and/or the external device 134.

The communication port 130 is configured to transmit image data or signals by any suitable wireless or wired communication means.

The imaging apparatus 310 may be configured as an auxiliary attachment and may be formed as a ring or any other unit attachable to the pole 302, as shown in FIGS. 12A and 12B, where the pole 302 may comprise a standard commercial pole. The auxiliary attachment may be positioned at any suitable location along the pole 302. In some embodiments, the auxiliary attachment may be slidable along the pole 302 so as to allow adjusting the distance of the camera 114 from a targeted imaging region 116.

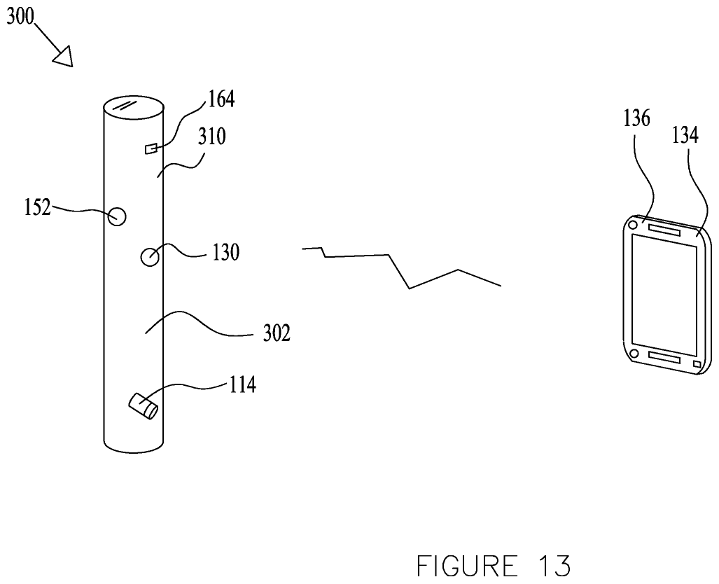

Turning to FIG. 13 is it shown that the imaging apparatus 310 may be embedded within a pole 302 forming together a monolithic unit.

In some embodiments, the imaging apparatus 310 may further comprise any one of the components described herein with reference to FIGS. 1-11, such as the power source 152, as well as electronic components and/or connectors 166 and illuminator 160. Sensors 192 and/or audio components 194 may be included as well.

In some embodiments, the imaging apparatus system 300 may be configured to perform any of the plurality of functions described herein, such as functions related to image capturing of the imaging region 116. In a non-limiting example, such functions may include: turning the imaging apparatus 310 on or off, magnifying the field of the image size by zooming in or out, adjusting the angle of the image to be captured, capturing the image, saving the captured image, sharing the image with other users, turning the illuminator 160 on or off, 3D rotation of the image, etc.

Furthermore, the functions may include a plurality of activities such as mechanical activities, visual activities, acoustical activities, wired or wireless activities and a combination thereof, which may be performed by any component of the imaging apparatus system 300.

In some embodiments, these functions may be controlled by an application operating on the mobile device 136.

Additionally, or alternatively, the functions may be controlled, at least partially, by the signaling mechanism (described herein) configured to generate signals by the imaging apparatus 310. In some embodiments, the imaging apparatus 310 may be formed with a signal generator which upon prompting generates a signal, thereby activating a function in response to the signal. The signal may be generated in any suitable manner, such as by pressing a button on the imaging apparatus 310 or pole 302. The signal may be generated upon agitating the imaging apparatus 310 or pole 302, by moving, striking, tapping or touching it, for example.

Some exemplary signal patterns generating preprogrammed functions may include: an initial tapping (e.g. by a user tapping the pole or by tapping the pole against another object) of the pole 302 may generate a signal to activate the mobile device 136 and/or the imaging apparatus 310; a double tapping of the pole 302 in rapid succession may generate another signal, which may trigger turning the illuminator 160 on; a tapping of the pole 302 without any further detected activity following a predetermined time thereafter may generate a signal to deactivate the mobile device 136 and/or the imaging apparatus 310, thereby conserving the energy of battery 152.

Other patterns of tapping of the pole 302 may generate a signal to capture the image and/or transmit the captured image to the mobile device 136. It is appreciated that the controller 164 may be programmed to activate many different types of functions related to the operation of the imaging apparatus 310 and/or the external device 134 and/or the communication therebetween.

The signal may be generated in any suitable manner as described hereinabove in reference to FIGS. 1-11.

In some embodiments, the imaging apparatus 310 may further comprise the audio components 194. Upon generation of the signal, an audio signal (e.g. beep) may be generated and detected by sensor 192. The audio signals may serve to aid in monitoring the generated signals. For example, the audio signals may be used to indicate the number, duration of the tappings and the intervals between consecutive tappings of the pole 302.

In some embodiments, the imaging apparatus 310 may be configured with a plurality⁻ of buttons and controllers which may replace or may be added to the signaling mechanism.

In some embodiments, the audio components 194 may comprise a microphone for controlling the imaging apparatus system 300 verbally by employing speech recognition functionality. This may be used by visually impaired users, for example.

In some embodiments, the imaging apparatus 310 may comprise a plurality of cameras 114, such as first and second cameras 142 and 144 provided for constructing a three-dimensional (3D) image from the captured image frame or for providing relatively small or wider fields of view or for imaging different imaging regions 116.

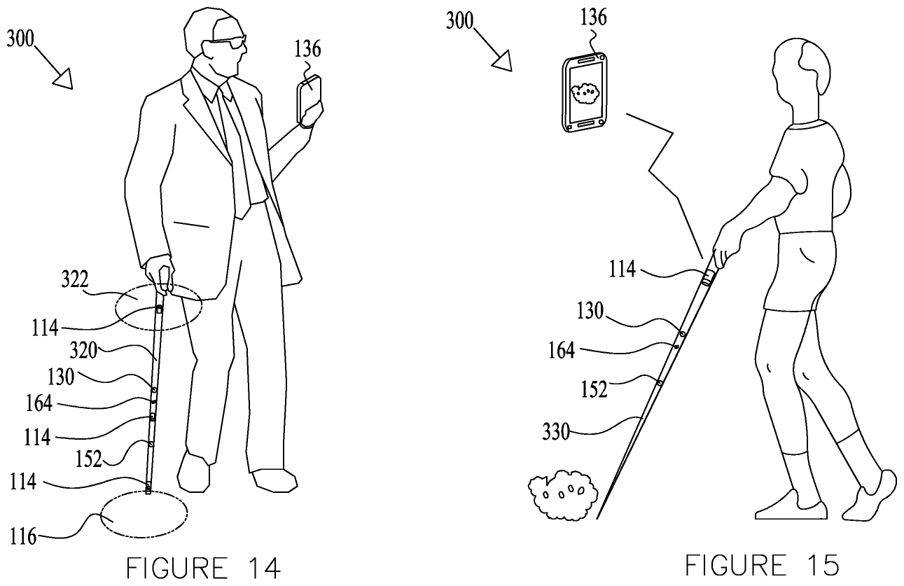

Referring to FIGS. 14-16, some exemplary imaging apparatus systems 300 are shown, wherein the imaging apparatus 310 may be configured within a pole 302. The camera 114 captures the image at an imaging region 116. The captured image is transmitted to an external device 134, such as a mobile device 136. The communication port 130 may be configured to transmit the image data to the mobile device 136 whereupon the mobile device 136 is located at a remote distance from the imaging apparatus 310. In a non-limiting example, the remote distance may include about 0.5 meters or less, or about 1 meter or less, or about 2 meters or less, or about 3 meters or less, or more than 3 meters and subranges thereof.

In one example, the pole 302. along with the imaging apparatus 310 may be used to visualize and magnify inaccessible locations, such as in pipes or conduits.

As seen in FIG. 14, the pole 302 is employed as a cane 320 used to aid an elderly or visually impaired user. The imaging apparatus 310 may be embedded in the cane 320. A single camera 114 or a plurality of cameras 114 may be placed along the cane 320 and may transmit (e.g. stream) live images of obstacles placed on the ground at the imaging region 116 to a mobile device 136, thereby magnifying the otherwise invisible obstacles to the user.

The plurality of cameras 114 may be used to capture the images of different imaging regions 116, such as an imaging region 116 comprising the ground and an imaging region 322 comprising the vicinity at the user waist level.

In FIG. 15 the pole 302 is employed as a hiking stick 330 used to aid a hiker. The camera 114 within the imaging apparatus 310 may be placed along the hiking stick 330 and may stream live images of obstacles placed on the hiking path to a mobile device 136, thereby magnifying the otherwise invisible obstacles to the hiker.

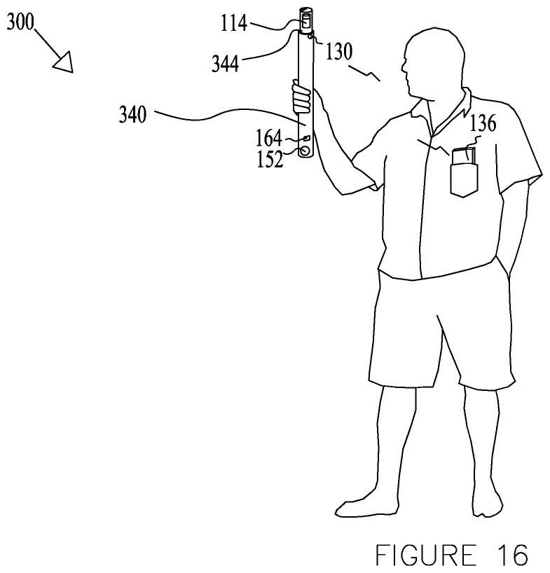

Turning to FIG. 16 it is shown that the imaging apparatus 310 is embedded in a pole 302 comprising a selfie stick, i.e. a camera rod 340. The camera 114 is shown to be positioned on a top portion of the rod 340, which may include an extendable portion 344. The camera rod 340, comprising the camera 114, may replace the traditional selfie stick with a mobile device 136 fixed thereto. By employing the camera rod 340, the mobile device 136 may be placed in a secure area away from the camera rod 340 , thus avoiding the inadvertent and prevalent dropping of the mobile device 136 from the selfie stick.

It is noted that the imaging apparatus system 300 is described in reference to a pole 302 or any other elongated instrument. It is appreciated that the imaging apparatus 310 may be inserted on or embedded within an instrument configured with any type shape or form (e.g. sphere, pyramid, cube and combinations thereof).

There is provided a method for imaging an imaging region via an imaging application operating on the mobile device 136. The method may comprise activating the imaging application on the mobile device 136. Receiving image data from the imaging apparatus 310 equipped with the camera 114 capturing an image of the imaging region 116. The received image data is processed, generally by the controller 164, and the resultant image is displayed on display 138 of the mobile device 136.

Various implementations of some of embodiments disclosed, in particular at least some of the processes discussed (or portions thereof), may be realized in digital electronic circuitry, integrated circuitry, specially configured ASICs (application specific integrated circuits), computer hardware, firmware, software, and/or combinations thereof. These various implementations, such as associated with the system 100 the components thereof, for example, may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Such computer programs (also known as programs, software, software applications or code) include machine instructions/code for a programmable processor, for example, and may be implemented in a high-level procedural and/or object-oriented programming language, and/or in assembly/machine language. As used herein, the term “machine-readable medium” refers to any computer program product, apparatus and/or device (e.g., non-transitory mediums including, for example, magnetic discs, optical disks, flash memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a LCD (liquid crystal display) monitor and the like) for displaying information to the user and a keyboard and/or a pointing device (e.g., a mouse or a trackball, touchscreen) by which the user may provide input to the computer. For example, this program can be stored, executed and operated by the dispensing unit, remote control, PC, laptop, smartphone, media player or personal data assistant (“PDA”). Other kinds of devices may be used to provide for interaction with a user as well. For example, feedback provided to the user may be any form of sensory feedback (e.g., visual feedback, auditory feedback, or tactile feedback), and input from the user may be received in any form, including acoustic, speech, or tactile input. Certain embodiments of the subject matter described herein may be implemented in a computing system and/or devices that includes a back-end component (e.g., as a data server), or that includes a middleware component (e.g., an application server), or that includes a front-end component (e.g., a client computer having a graphical user interface or a Web browser through which a user may interact with an implementation of the subject matter described. herein), or any combination of such back-end, middleware, or front-end components.

The components of the system may be interconnected by any form or medium of digital data communication (e.g., a communication network). Examples of communication networks include a local area network (“LAN”), a wide area network (“WAN”), and the Internet. The computing system according to some such embodiments described above may include clients and servers. A client and server are generally remote from each other and typically interact through a communication network. The relationship of client and server arises by virtue of computer programs running on the respective computers and having a client-server relation to each other.

Any and all references to publications or other documents, including but not limited to, patents, patent applications, articles, webpages, books, etc., presented anywhere in the present application, are herein incorporated by reference in their entirety.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A pincer apparatus, comprising:
two arms forming a pair of jaws at tips of the arms;
a base region positioned opposite end of the arms;
at least one camera positioned at the base region or in proximity to the base region;
a communication port for transmitting an image captured by the camera to an external device comprising an image display; and
a power supply source configured to supply power to the camera and the communication port.

2. A pincer apparatus according to claim 1 wherein the external device comprises a mobile device.

3. A pincer apparatus according to claim 1, comprising a first and second camera configured for constructing a three-dimensional image from a plurality of images captured by the first and second cameras.

4. A pincer apparatus according to claim 1, comprising a first and second camera, the first camera being configured with a relatively narrow optical lens to provide a relatively narrow field of view and the second camera is configured with a relatively wide optical lens to provide a relatively larger field of view.

5. A pincer apparatus according to claim 1, further comprising a base element, and wherein the two arms are connected thereto via the base element, and wherein the two arms are formed of an electrically conducting material and the base element is formed of an electrically isolating material.

6. A pincer apparatus according to claim 5, wherein upon mutual contact of the tips formed of the electrically conducting material, a signal is generated.

7. A pincer apparatus according to claim 6 and further comprising a controller, the controller receiving the signal and being programmed to activate a function in response to the signal.

8. A pincer apparatus according to claim 6 and further comprising a sensor for detecting the signal.

9. A pincer apparatus according to claim 1 and further comprising adapters structured with a selected tool for performing a procedure, the adapters being shaped to be inserted on the tips.

10. A pincer apparatus according to claim 1 wherein the pincer apparatus comprises tweezers configured for hair removal.

11. A pincer apparatus system comprising:
a pincer apparatus, comprising:
two arms forming a pair of jaws at tips of the arms;
a base region positioned opposite end of the arms;
at least one camera positioned at the base region or in proximity to the base region;
a communication port for transmitting an image captured by the camera to an external device comprising an image display; and
a power supply source configured to supply power to the camera and the communication port; and
an external device comprising:
a receiver port for receiving images captured by the camera and transmitted from the communication port; and
an image display for displaying the captured images thereon.

12. A pincer apparatus system according to claim 11 and further comprising a base element, wherein the two arms are connected thereto via the base element, and wherein the two arms are formed of an electrically conducting material and the base element is formed of an electrically isolating material.

13. A pincer apparatus system according to claim 12, wherein upon mutual contact of the tips formed of the electrically conducting material, a signal is generated.

14. A pincer apparatus system according to claim 13 and further comprising a controller, the controller receiving the signal and being programmed to activate a function in response to the signal.

15. A pincer apparatus system according to claim 13 and further comprising a sensor for detecting the signal.

16. The pincer apparatus system of claim 11 and further comprising adapters structured with a selected tool for performing a procedure, the adapters being shaped to be inserted on the tips.

17. (canceled)

18. A method for imaging a gripping procedure via a gripping procedure imaging application operating on a mobile device, the method comprising:
activating the imaging application on the mobile device;
receiving image data from a pincer apparatus equipped with a camera for capturing an image of the gripping procedure;
processing the received image data; and
displaying the resultant captured image on a display of the mobile device.

19. The method of claim 18 further comprising manipulating the image.

20. The method of claim 18 further comprising transmitting the image data to other devices comprising a display.

21-32. (canceled)
